(19) United States
(12) Patent Application Publication
(10) Pub. No.: US 2006/0037541 A1
(43) Pub. Date: Feb. 23, 2006

(54) Milking device

(75) Inventors: Lars Wase, DANDERYD (SE); Mats Forsberg, Orsundsbro (SE)

Correspondence Address: HOVEY WILLIAMS LLP, 2405 GRAND BLVD., SUITE 400, KANSAS CITY, MO, 64108, US

(73) Assignee: DELAVAL HOLDING AB, TUMBA (SE)

(21) Appl. No.: 10/532,274

(22) PCT Filed: Sep. 16, 2003
(86) PCT No.: PCT/SE03/01449

§ 371 Date: Apr. 21, 2005

(30) Foreign Application Priority Data
Oct. 30, 2002 (SE) 0203197.9

(51) Int. Cl. A01J 5/04

(52) U.S. Cl. 119/14.27

(57) ABSTRACT

The invention relates to a milking device, which includes a milk-transporting conduit containing at least one teat cup arranged to be attached to a teat of an animal to be milked, and a milk hose to permit a transportation of milk from the teat to a milk-collecting member. The milking device also includes a pump device and a gas supply system. The pump device is connected to the milk-collecting member via the milk-transporting conduit. The gas supply system is arranged to support the transportation of milk by supplying a gas at an atmospheric pressure level. The gas supply system, in turn, includes a gas conditioning sub-system and a gas inlet member. The gas conditioning sub-system is arranged to receive an unconditioned gas, and in response thereto, produce a conditioned gas fulfilling at least one quality criterion. The gas inlet member is arranged to introduce the conditioned gas into the milk-transporting conduit and thus permit the transportation of milk. The gas conditioning sub-system is also arranged to supply the conditioned gas to at least one auxiliary gas consuming point of the milking device outside the milk-transporting conduit.

### THE BACKGROUND OF THE INVENTION AND PRIOR ART

The present invention relates generally to machine milking of animals. More particularly the invention relates to a milking device according to the preamble of claim 1.

The prior art includes many examples of milking machines to which air or a similar gas is supplied in order to render milk transportation possible when extracting milk from the teats of the milked animals. The gas supply is here necessary to allow milk to be transported by means of a vacuum pressure in the milk-transporting conduit. The earliest systems of this type included a passive air intake, which allowed the ambient air from the stable building to be drawn into the milk-transporting conduit by means of suction effect. The U.S. Pat. No. 4,303,038 describes a solution of this kind, where air is admitted into a flexible inflation of a teat cup assembly in order to aid the flow of milk. However, more recent and sophisticated solutions involve an active gas supply in combination with filtering. In some cases the gas also has a particular composition and may be taken from a gas cylinder.

The international patent application WO96/17509 discloses one example of an implement for milking animals where filtered air is allowed into a milking line through a suction line, either directly, or via a filter and air compression device. The international patent application WO01/19176 represents another prior-art example, by describing a milking machine in which gas is admitted into the interface region between the teat cup and the suction hose. The gas is here either filtered outside air or it has a certain composition, such that it is comparatively free from undesired components, for instance ammonia.

Nevertheless, today's large scale milking installations with relatively many simultaneous milking points and other gas or air controlled/supported devices render the gas supply expensive and requires an intricate design. This is particularly true if a very high gas quality is demanded.

### SUMMARY OF THE INVENTION

The object of the present invention is therefore to alleviate the problem above and thus provide a milking device by means of which a high-quality gas may be supplied efficiently to all positions in a milking device where such gas is required.

According to the invention the object is achieved by the initially described milking device, which is characterized in that the gas conditioning sub-system is arranged to supply the conditioned gas to at least one auxiliary gas consuming point of the milking device outside the milk-transporting conduit.

An important advantage attained by this strategy is that the gas supply system may be centralized with respect to all gas consuming points, i.e. not exclusively the gas inlets that are necessary for the transportation of milk. This, in turn, results in a more cost efficient and less error prone design. Moreover, high-quality gas may be utilized for purposes and devices which otherwise would have utilized a gas of a lower quality. This, of course, further increases the reliability and prolongs the life time of the system. Additionally, since the gas fed to the gas consuming points is guaranteed to fulfill certain quality criteria, the design of the equipment attached to these points may be simplified and made less expensive. For example, local filtering, heating, cooling and/or corrosion protecting means will not be required to the same extent as if, for example, ambient air were taken from the stable or outside the building. Furthermore, the service and maintenance costs for the proposed device are expected to become relatively low.

According to one preferred embodiment of the invention, the at least one auxiliary gas consuming point includes a constant-pressure valve, which is arranged between the pump device and the milk collecting member in order to maintain a desired pressure level of the vacuum pressure.

According to one preferred embodiment of the invention, the at least one auxiliary gas consuming point includes a pneumatic member, which is arranged to effect a working operation during use of the milking device. For instance, the conditioned gas may be used by the pneumatic member for automatic removal of a teat cup cluster from the teat after completion of the milking. This is advantageous because the high quality of the gas reduces the risk that any undesired particles or substances enter into the cylinder and piston mechanism of the pneumatic member.

According to another preferred embodiment of the invention, the at least one auxiliary gas consuming point includes a compressor, which is adapted to receive the conditioned gas and produce a conditioned gas at an elevated pressure level that exceeds the atmospheric pressure level. Conditioned gas at a pressure level exceeding the atmospheric pressure level may then, in turn, be utilized by secondary gas consuming points which require supply of a gas at a relatively high pressure.

According to one preferred embodiment of the invention, the at least one secondary gas consuming point includes a cabinet containing electronic equipment, which may be adapted to detect an operating condition of the milking device. The cabinet is arranged to receive the conditioned gas at a pressure level above the atmospheric pressure level, and thus pressurize an interior volume of the cabinet. This is advantageous because the supply of high-quality gas makes it possible to design the cabinet with relatively low air tightness requirements while maintaining a good resistance against any aggressive substances outside the cabinet. Naturally, the cabinet thereby becomes less expensive and, at the same time, more reliable. Furthermore, if nevertheless, moisture or any other undesired elements have entered into the cabinet, the gas supply will assist In removing them from the cabinet.

According to another preferred embodiment of the invention, the at least one secondary gas consuming point includes a cabinet containing electronic equipment. The cabinet is here also arranged to receive the conditioned gas at a pressure level above the atmospheric pressure level, however for ventilating an interior volume of the cabinet. The gas may thus either heat or cool components in the cabinet to a desired temperature level, depending on their relative temperature of the cabinet and the gas respectively. This is particularly advantageous if the gas conditioning sub-system includes a heating and/or a cooling member to ensure that the temperature of the conditioned gas lies within a relatively narrow temperature interval. Namely, such interval typically overlaps the range of suitable operating temperatures for the electronic equipment in the cabinet.

According to yet another preferred embodiment of the invention, the at least one secondary gas consuming point includes a cleaning member, which is adapted to clean a sensor by blowing conditioned gas at a pressure level above the atmospheric pressure level towards the sensor. The sensor may in turn be arranged to detect an operating condition of the milking device and/or register a parameter related to the milk collection. Such cleaning arrangement is desirable because it is reliable, technically efficient as well as cost efficient.

According to yet another preferred embodiment of the invention, the at least one quality criterion relates to the temperature of the conditioned gas. The gas conditioning sub-system therefore includes a heating member, which is adapted to heat the gas to a particular minimum temperature. Such heating member is desirable, since it enables outdoor air to be fed in also when this air has a low temperature, for example in the winter time.

According to yet another preferred embodiment of the invention, the at least one quality criterion relates to the temperature of the conditioned gas. The gas conditioning sub-system therefore includes a cooling member, which is adapted to cool the gas to a particular maximum temperature. Thereby ambient air, either from the stable or outside the building may be used even though this air initially is too hot to be fed into the milking device.

According to yet another preferred embodiment of the invention, the at least one quality criterion relates to the purity and/or composition of the conditioned gas. Therefore, the gas conditioning sub-system includes a filter, which is arranged to permit air to be sucked in from either outside the stable, or from inside the stable, however from a portion of the building where the atmosphere is at least relatively free from ammonia. Alternatively, the gas conditioning sub-system includes a pressurized gas container, which is arranged to feed gas of a particular composition into the gas supply system, and a pressure regulator, which is arranged to receive gas from the gas container and deliver gas at the atmospheric pressure level to the gas supply system. In any case, an appropriate filtering render the risk that undesired gases, particles or substances enter into the gas supply system relatively low. Naturally, this is desirable both with respect to the milk transportation and the gas consuming points outside the milk transporting conduit.

The proposed invention generally enhances the automated milking process by rendering it more efficient, more cost effective and more reliable than the earlier known solutions.

### BRIEF DESCRIPTION OF THE DRAWINGS

The present invention is now to be explained more closely by means of preferred embodiments, which are disclosed as examples, and with reference to the attached drawings.

FIG. 1 shows a schematic view of a milking device according to a first embodiment of the invention and

FIG. 2 shows a schematic view of a milking device according to a second embodiment of the invention.

### DESCRIPTION OF PREFERRED EMBODIMENTS OF THE INVENTION

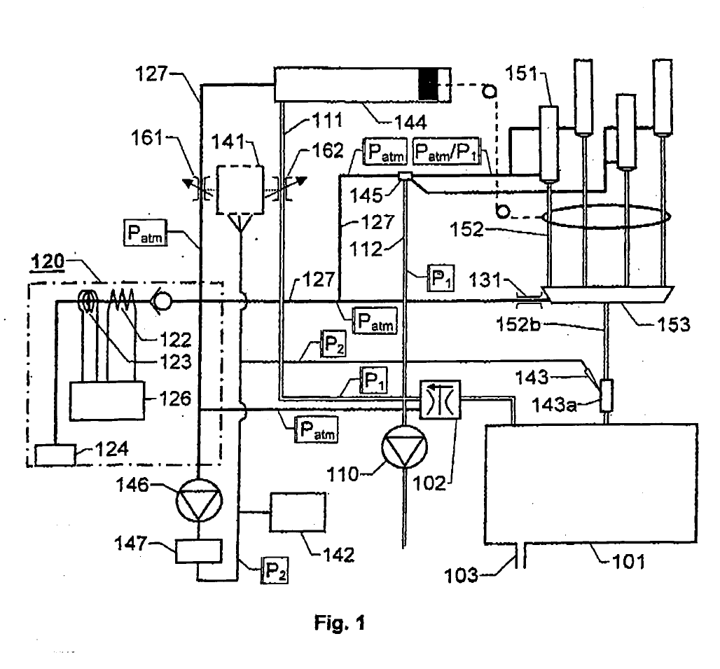

FIG. 1 illustrates a milking device for milking animals, such as cows, according to a first embodiment of the invention. The milking device here includes a milk-transporting conduit where four first milk hoses 152 are connected between a respective teat cup 151 and a so-called milking claw 153. The milking claw 153 is further connected to a milk collecting member 101 via a second milk hose 152b. A sensor 143a is arranged on the second milk hose 152 in order to register one or more parameters related to properties of the milk (e.g. the amount per time unit) that flows through the second milk hose 152b to the milk collecting member 101. Preferably, an outlet 103 connects the milk collecting member 101 via a milk pump (not shown) to a tank (not shown) for storage of the milk. It should be noted that FIG. 1 represents a schematic illustration of the milking device. Therefore, an actual milking device according to the invention may include components and/or hoses in addition to those that are mentioned and illustrated here.

A pump device 110 is connected to the milk-transporting conduit, preferably via the milk collecting member 101. The pump device 110 is arranged to produce a pressure of a first pressure level P₁, which is below the atmospheric pressure level Pₐₜₘ, i.e. a so-called vacuum pressure. Thereby, milk may be sucked from the teat into the teat cup 151 and be further transported to the milk-collecting member 101 via the milk hoses 152 and 152b respectively. Preferably, a constant-pressure valve 102 is arranged between the pump device 110 and the milk collecting member 101, such that a desired vacuum level P₁ may be maintained in the milk-transporting conduit. In order to maintain a desired milk flow and to prevent an excessive negative pressure to be developed, a gas supply system is arranged to support the transportation of milk by supplying a gas at the atmospheric pressure level Pₐₜₘ. The gas supply system includes a gas conditioning sub-system 120, a gas inlet member 131 to the second milk hose 152b and at least one auxiliary gas consuming point 102, 141, 142, 143, 144, 145 and 146 outside the milk-transporting conduit, such as the constant-pressure valve 102, a pneumatic member 144, a bi-stable switch (pulsator) 145, a compressor 146, cabinets 141 and 142 and a cleaning member 143. Furthermore, a teat cleaning device (not shown) adapted to wash the animal's teats prior to initiating the milking may also use gas provided by the gas conditioning sub-system 120. Preferably, the teat cleaning device uses a mixture, of pressurized gas from a compressor and water in a cleaning cup to remove any dirt from a teat. The vacuum pressure P₁ is then used to remove the used water from the cleaning cup after completing the cleaning process.

FIG. 1 shows the gas inlet member 131 as being located in the milking claw 153. An alternative location of a gas inlet member 131 on each of the first milk hoses 152 is, however, equally well conceivable.

The gas conditioning sub-system 120 is arranged to receive an unconditioned gas and produce a conditioned gas that fulfills at least one quality criterion. The quality criterion may relate to the composition of the gas, its purity (i.e. the amount of undesired constituents therein) or the temperature range of the conditioned gas. In order to fulfill the at least one quality criterion, the gas conditioning sub-system 120 may include one or more of the following quality-enhancing means; a filter 124, which is arranged to permit air to be sucked in (either from outside a building in which the animal to be milked is located, or from a portion inside this building where the atmosphere is at least relatively free from ammonia); a heating member 122, which is adapted to heat the gas to a particular minimum temperature; and a cooling member 123, which is adapted to cool the gas to a particular maximum temperature.

For illustrating purposes, the gas conditioning sub-system 120 of the milking device in FIG. 1 includes all the above examples of quality-enhancing means. Thus, a filter 124 is arranged in an air intake member to the gas conditioning sub-system 120, such that air (i.e. unconditioned gas) is permitted to be sucked into the gas conditioning sub-system 120 via said filter 124. Thereby undesired gases, such as ammonia and other undesired constituents, which often are present within the building can be avoided efficiently In the gas supply system. The filter 124 may either be a particle filter (e.g. adapted to receive air from outside the building in which the animal to be milked is located) or a chemical filter (e.g. including active carbon adapted to receive air from inside the stable building).

The filtered incoming air then passes a heating member 122 in the flow path. The heating member 122 is adapted to heat the gas to a particular minimum temperature. Correspondingly, a cooling member 123 in the flow path is adapted to cool the gas to a particular maximum temperature. Hence, the heating member 122 and the cooling member 123 together limit the temperature of the conditioned gas to a specific temperature interval. Preferably, the heating member 122 and the cooling member 123 are controlled by a common control unit 126. However, two separate control units are equally well conceivable. Conditioned gas that fulfills the at least one quality criterion leaves the conditioning sub-system 120, preferably via a one-way valve, whereafter the gas flows into a set of gas conduits 127 to the gas inlet member 131 and the auxiliary gas consuming points 102, 141, 142, 143, 144 and 146 respectively. Naturally, the conditioned gas must fulfill all the required quality criteria. However, the number of required quality criteria may be set as low as one. The gas inlet member 131 connected to the set of gas conduits 127 is arranged to introduce the conditioned gas into the milk-transporting conduit and thereby permit the transportation of milk from the teat cup 151 to the milk collecting member 101.

For illustrating purposes, the milking device in FIG. 1 includes a number of exemplifying auxiliary gas consuming points 102, 144, 145 and 146 that receive conditioned gas directly from the conditioning sub-system 120 via the set of gas conduits 127. Namely, it is sufficient to feed conditioned gas at the atmospheric pressure level Pₐₜₘ to these auxiliary gas consuming points. The constant-pressure valve 102 that operates the pulsator has already been discussed above. An advantage attained by feeding conditioned gas to the valve 102, instead of the surrounding air, is that thereby the risk that impurities or contaminating substances are introduced into the milk flow is minimized.

The pneumatic member 144, which is arranged to effect a working operation during use of the milking device, constitutes another example. The pneumatic member 144 is here specifically adapted to automatically remove a teat cup cluster (typically containing four individual teat cups 151, which each is adapted to contact a teat during the milking) from the animal's udder after completion of the milking, via a cylinder-piston and wire arrangement. A pair of valves 161 and 162 regulate the amount of gas fed to and from the pneumatic member 144, and thereby control its operation in accordance with control signals generated by control circuitry in a first cabinet 141. A first valve 161 lets conditioned gas (at the atmospheric pressure level Pₐₜₘ) into the pneumatic member 144 and thus allows the teat cups 151 to approach the teats. A second valve 162 accomplishes the first pressure level P₁ (i.e. below atmospheric) within the pneumatic member 144 by connecting the member to the pump means 110 via a gas conduit 111. Thereby, a removal of the teat cups 151 from the teats is achieved.

The bi-stable switch (pulsator) 145 uses both the conditioned gas at the atmospheric pressure level Pₐₜₘ and gas at the vacuum pressure level P₁. The bi-stable switch 145 produces a pulsating action in the teat cup 151 and hence extracts milk from the teats. Namely, the bi-stable switch 145 alternately connects the teat cup 151 to the gas conditioning sub-system 120 via the gas conduits 127 and to the pump means 110 via a gas conduit 112.

The compressor 146 receives the conditioned gas at the atmospheric pressure level Pₐₜₘ and produces a conditioned gas at an elevated pressure level P₂, which exceeds the atmospheric pressure level Pₐₜₘ. The conditioned gas at the elevated pressure level P₂ may thus be used by auxiliary gas consuming points which require (or at least benefit from) a high-quality gas at a relatively high pressure level. A pressure regulator 147 in the gas flow path after the compressor 146 is adapted to accomplish the elevated pressure level P₂ within a certain tolerance range. Additionally, a gas tank (not shown) may be included in the gas flow path between the compressor 146 and the pressure regulator 147 in order to render it easier to uphold a stable pressure level P₂. Naturally, one or more additional pressure regulators (not shown) may also be included in the gas supply system, such that conditioned gas can be delivered to gas consuming points at other pressure levels than P₂.

The first cabinet 141 includes electronic equipment for controlling the valves 161 and 162. Additionally, the first cabinet 141 may contain electronic equipment which is adapted to detect one or more operating conditions of the milking device, register parameters related to the milk collection etc. In any case, the first cabinet 141 is arranged to receive the conditioned gas at the elevated pressure level P₂ in order to ventilate (e.g. cool or heat) components therein. This is, in fact, very advantageous, since the conditioned gas, in addition to being clean, may be regulated within a relatively narrow temperature interval, which normally also is ideal with respect to the components in the first cabinet 141.

A second cabinet 142 which also contains electronic equipment, for instance adapted to detect an operating condition of the milking device, constitutes another example of an auxiliary gas consuming point, which receives the conditioned gas at the elevated pressure level P₂. The second cabinet 142 is arranged to receive this gas and thus pressurize an interior volume of the second cabinet 142. Thereby, since the internal pressure of the second cabinet 142 exceeds the atmospheric pressure level Pₐₜₘ outside the second cabinet 142, cabinet obtains a good resistance against any exterior aggressive substances without having to be completely air tight. Moreover, if moisture or any other undesired elements have entered into the second cabinet 142, the gas supply at the elevated pressure level P₂ assists in removing them from the cabinet.

The sensor 143a is arranged to register a parameter related to the milk collection, such as the amount of milk per time unit that flows through the milk hose 152b. The cleaning member 143 is in turn adapted to clean the third sensor 143a by blowing conditioned gas at the elevated pressure level P₂ towards the sensor 143a. Such cleaning, of course, requires that the conditioned gas fulfills certain quality criteria, at least with respect to purity.

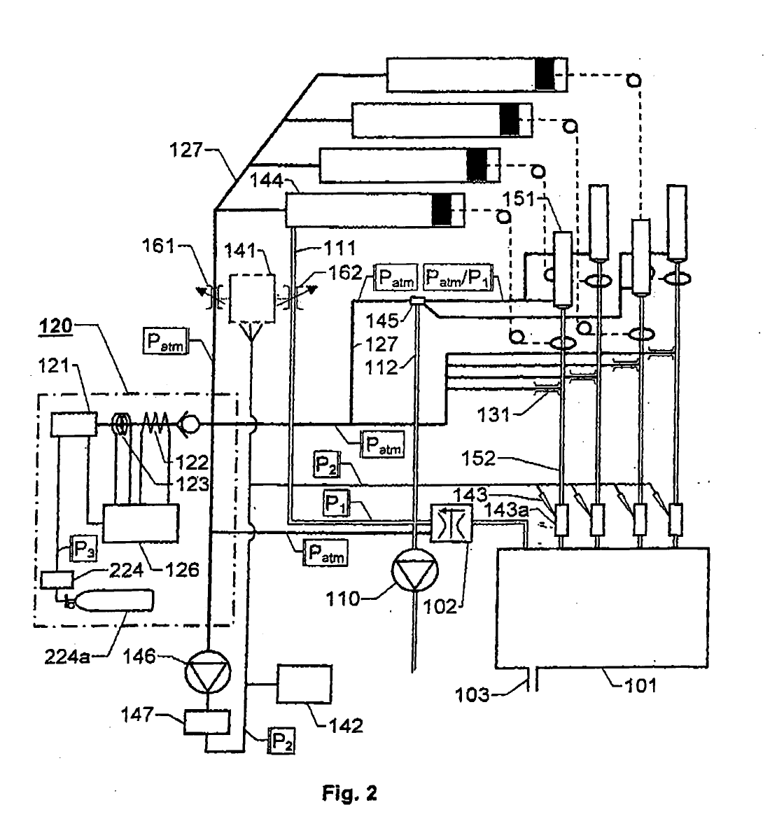

FIG. 2 illustrates a milking device for milking animals according to a second embodiment of the invention. Reference numerals that are identical with those of FIG. 1 designate the same elements as discussed above with reference to this figure.

Also in this case, the at least one quality criterion may relate to the purity of the conditioned gas. However, the gas conditioning sub-system 120 here includes a pressurized gas container 224a, which is arranged to feed gas of a particular composition into the gas supply system. Optionally, a filter 224 is included in the flow path in the gas conditioning sub-system 120 after the gas container 224a. The filter 224 is adapted to prevent any undesired components of the incoming gas from propagating in the gas supply system.

The gas container 224a delivers a gas at a pressure level P₃ that highly depends on the amount of gas contained in the container 224a. Normally, this pressure level P₃ exceeds the atmospheric pressure level Pₐₜₘ. Therefore, the gas conditioning sub-system 120 includes a pressure regulator 121, which is adapted to accomplish a pressure level, which lies as close as possible to the atmospheric pressure level Pₐₜₘ. Consequently, the gas conditioning sub-system 120 delivers the conditioned gas at the atmospheric pressure level Pₐₜₘ also in this case.

In contrast to the embodiment of the invention described above with reference to FIG. 1, FIG. 2 shows a separate gas inlet member 131 on each of the milk hoses 152 that connects a particular teat cup 151 (directly or indirectly) with the milk collecting member 101. So-called quarter milking (i.e. individual milk extraction from each teat of the animal's udder) is enabled by means of a particular pneumatic member 144 for automatic teat cup removal and a particular sensor 143a being associated with each teat. Thereby, the milk extraction from each teat may be monitored individually and the milking of a certain teat can be interrupted as soon as a particular criterion is fulfilled.

Naturally, any combination of gas supply sub-system 120 and type of milking device is conceivable according to the invention For instance, the gas supply sub-system 120 of FIG. 1 may be combined with the milking device of FIG. 2, and vice versa.

Although the invention primarily is intended to be utilized in connection with cow milking the invention is equally well adapted for milking any other kind of mammals, such as goats, sheep or buffaloes.

The invention is not restricted to the described embodiments in the figures, but may be varied freely within the scope of the claims.

1. A milking device including:
a milk-transporting conduit comprising at least one teat cup, arranged to be attached to a teat of an animal to be milked, and a milk hose to permit a transportation of milk from the teat to a milk-collecting member;
a pump device, connected to the milk-transporting conduit and arranged to produce a vacuum pressure for the transportation of milk by sucking milk from the teat to the milk-collecting member via the milk-transporting conduit; and
a gas supply system, arranged to support the transportation of milk by supplying a gas at an atmospheric pressure level, the gas supply system including
a gas conditioning sub-system arranged to receive an unconditioned gas and in response thereto produce a conditioned gas fulfilling at least one quality criterion, and
a gas inlet member arranged to introduce the conditioned gas into the milk-transporting conduit and thus permitting the transportation of milk,
wherein the gas conditioning sub-system is arranged to supply the conditioned gas to at least one auxiliary gas consuming point of the milking device outside the milk-transporting conduit.

2. A milking device according to claim 1, wherein the at least one auxiliary gas consuming point includes a constant-pressure valve arranged between the pump device and the milk collecting member to maintain a desired pressure level of the vacuum pressure.

3. A milking device according to claim 1, wherein the at least one auxiliary gas consuming point includes a pneumatic member arranged to effect a working operation during use of the milking device.

4. A milking device according to claim 3, wherein the pneumatic member is adapted to automatically remove a teat cup cluster from the teat after completion of the milking, the teat cup cluster containing the at least one teat cup.

5. A milking device according to claim 1, wherein the at least one auxiliary gas consuming point includes a compressor adapted to receive the conditioned gas and produce a conditioned gas at an elevated pressure level exceeding the atmospheric pressure level.

6. A milking device according to claim 5, wherein the at least one auxiliary gas consuming point includes at least one secondary gas consuming point in addition to the compressor, at least one secondary gas consuming point being connected to the compressor such that it receives the conditioned gas at a pressure level exceeding the atmospheric pressure level.

7. A milking device according to claim 6, wherein the at least one secondary gas consuming point includes a first cabinet containing electronic equipment, wherein the conditioned gas at a pressure level exceeding the atmospheric pressure level ventilates one or more components inside the first cabinet.

8. A milking device according to claim 7, wherein the at least one secondary gas consuming point includes a second cabinet containing electronic equipment, wherein the conditioned gas at a pressure level exceeding the atmospheric pressure level pressurizes an interior volume of the second cabinet.

9. A milking device according to claim 6, wherein the at least one secondary gas consuming point includes a cleaning member adapted to clean a sensor by blowing the conditioned gas at a pressure level exceeding the atmospheric pressure level towards the sensor.

10. A milking device according to claim 1, wherein the at least one quality criterion relates to the temperature of the conditioned gas, and the gas conditioning sub-system includes a heating member adapted to heat the unconditioned gas to a particular minimum temperature.

11. A milking device according to claim 1, wherein the at least one quality criterion relates to the temperature of the conditioned gas, and the gas conditioning sub-system includes a cooling member adapted to cool the unconditioned gas to a particular maximum temperature.

12. A milking device according to claim 1, wherein the at least one quality criterion relates to the purity of the conditioned gas, and the gas conditioning sub-system includes a filter.

13. A milking device according to claim 12, wherein the filter is arranged to permit unconditioned gas in the form of air to be sucked in from outside a building in which the animal to be milked is located.

14. A milking device according to claim 12, wherein the filter is arranged to permit unconditioned gas in the form of air to be sucked in from inside a portion of a building in which the animal to be milked is located, said portion containing an atmosphere which is at least substantially free from ammonia.

15. A milking device according to claim 1, wherein the at least one quality criterion relates to the composition of the conditioned gas, and the gas, conditioning sub-system includes:
a pressurized gas container arranged to feed gas of a particular composition into the gas supply system, and
a pressure regulator arranged to receive gas from the gas container and in response thereto deliver gas at the atmospheric pressure level to the gas supply system.

16. A milking device according to claim 2, wherein the at least one auxiliary gas consuming point includes a compressor adapted to receive the conditioned gas and produce a conditioned gas at an elevated pressure level exceeding the atmospheric pressure level.

17. A milking device according to claim 8, including a sensor, and wherein the at least one secondary gas consuming point includes a cleaning member adapted to clean the sensor by blowing the conditioned as at a member adapted to clean the sensor by blowing the conditioned gas at a pressure level exceeding the atmospheric pressure level towards the sensor.

18. A milking devices according to claim 5, wherein the at least one quality criterion relates to the temperature of the conditioned gas, and the gas conditioning sub-system includes a heating member adapted to heat the unconditioned gas to a particular minimum temperature.

19. A milking device according to claim 5, wherein the at least one quality criterion relates to the temperature of the conditioned gas, and the gas conditioning sub-system includes a cooling member adapted to cool the unconditioned gas to a particular maximum temperature.

20. A milking device according to claim 5, wherein the at least one quality criterion relates to the purity of the conditioned gas, and the gas conditioning sub-system includes a filter.
